(19) United States
(12) Patent Application Publication
(10) Pub. No.: US 2017/0126068 A1
(43) Pub. Date: May 4, 2017

(54) IMPROVEMENT IN, OR RELATING TO, PASSENGER/ENTERTAINMENT SYSTEMS

(71) Applicant: PHITEK SYSTEMS LIMITED, Auckland (NZ)

(72) Inventors: Nigel GREIG, Auckland (NZ); David MUTTON, Huntly (NZ)

(21) Appl. No.: 15/302,114

(22) PCT Filed: Apr. 8, 2015
(86) PCT No.: PCT/IB2015/052569

§ 371 Date: Oct. 5, 2016

(30) Foreign Application Priority Data
Apr. 8, 2014 (NZ) 623598

(51) Int. Cl. H02J 50/12; H02J 50/70; H02J 50/80; H04B 5/00

(52) U.S. Cl. CPC H02J 50/12; H04B 5/0037; H02J 50/70; H02J 50/80

(57) ABSTRACT

The present invention relates to passenger communication apparatus for supplying power wirelessly to passenger devices for systems such as in-flight entertainment (IFE) systems. The invention has particular application to the use of wireless equipment in passenger environments and may be broadly described as a passenger communication apparatus comprising a wireless power coupling device operable to provide a field for wireless power transfer in the vicinity of an occupant of a passenger seat to be received by a passenger device. In other embodiments the invention may be broadly described as an IFE system comprising a plurality of coupling devices or in a passenger device operable with the passenger communication apparatus.

### FIELD OF THE INVENTION

The present invention relates to passenger entertainment systems, such as in-flight entertainment (IFE) systems. The invention has particular application to the use of wireless equipment in passenger environments.

### BACKGROUND

Passenger entertainment systems usually involve headsets and/or screens which are used and/or viewed by passengers from passenger seats in vehicles, typically (but not limited to) buses and aircraft.

In the example of IFE systems, airlines traditionally hand out headphones so that passengers can enjoy inflight entertainment provided by equipment installed in the aircraft seats. Providing headphones to passengers is logistically difficult as headphones require cleaning after each use and are difficult to collect, each having loose or dangling cables. This is compounded as aircraft get larger requiring rapid collection of 300 to 500 headphones by cabin staff which must later be separated, cleaned, tested and packaged by ground staff.

Having cables on headphones tethers passengers to seats which creates an obstacle for passenger movement within the tight seat space as well as a trip and catch hazard for neighbouring passengers leaving their seat.

Although wireless headphones may be seen as a simple solution, implementation of a wireless solution poses its own problems in aircraft environments due to restrictions on wireless communications, frequency bands and the number of users in a confined area. Any solution must not cost significantly more than the very low cost economy headphones, and the transmission method must be provided such that hundreds of passengers within a close space can experience different program channels without cross seat signal interference.

Wireless solutions also involve not only the problem of communicating information wirelessly, but also the problem of provision of power for the wireless devices to operate.

### OBJECTS OF THE INVENTION

It is an object of the invention to provide a passenger entertainment system, or apparatus or methods for such systems that will at least go some way to overcoming disadvantages of existing systems, apparatus or methods, or which will at least provide a useful alternative to existing systems, apparatus or methods.

Further objects of the invention will become apparent from the following description.

### SUMMARY OF INVENTION

In one aspect the invention broadly provides passenger entertainment apparatus comprising a wireless power transfer antenna or coupling device operable to provide a field for wireless power transfer in the vicinity of an occupant of a passenger seat.

In one embodiment the field is suitable for providing power to a passenger entertainment or communication device such as without limitation a headset, earpiece, glasses, phone, tablet or other portable electronic device.

In one embodiment the coupling device provides a field which also contains information for reception by a passenger entertainment or communication device.

In an embodiment the field is a carrier wave for the information.

In an embodiment the information is carried by amplitude modulation or frequency modulation.

In an embodiment the field has a plurality of resonant frequencies wherein a first resonant frequencies is adapted to transmit a power signal and a second resonant frequency is adapted to transmit a data signal.

In another embodiment the coupling device facilitates communication between a passenger entertainment system and a passenger entertainment or communication device.

The field may be provided in a required location relative to the passenger seat. For example, the field may be provided adjacent to the head of a user (i.e. passenger or seat occupant), or the head and torso of a user.

In one embodiment the coupling device is provided in or on a passenger seat. The field from the device may be projected into a defined area, so in some embodiments the device may be located in or on or adjacent to the headrest of the seat to direct the field into a space normally occupied by the seat occupant. In other embodiments the device may be located in a seat in front of the seat occupant.

In an embodiment the field is provided to a headphone by a device located in or on a head or head position of a seat.

In an embodiment a plurality of devices are located on the head of the seat.

In an embodiment the devices are located on a support means which is attachable to a seat.

In an embodiment the devices are located on a flexible support.

In an embodiment the devices are removably attached to a portion of the seat.

In an embodiment a plurality of devices are located in or on or adjacent to the seat.

In an embodiment a plurality of repeater devices are located in or on or adjacent to the seat.

In an embodiment a plurality of devices are located in or on or adjacent to the seat and an adjacent seat to create a field in an area covering multiple seats.

In an embodiment the portable electronic device is powered by and receives a signal from the device.

In an embodiment the portable electronic device is a headphone.

In an embodiment the portable electronic device does not have a battery.

In an embodiment the portable electronic device has a speaker means which is powered directly from the audio signal.

In an embodiment the portable electronic device comprises a receiver means and a filter means.

In another embodiment the coupling device is provided externally of the seat. For example the device may be located above or below the seat, but be adapted to provide a field in the required location, or at least a field that extends to the required location.

In one embodiment the device includes a coil which is shaped or energised to provide a field having the required spatial characteristics. In other embodiments the device includes materials to shape or direct the field e.g. materials that reflect and/or absorb parts or components of the field to attain the required spatial characteristics.

In an embodiment the materials may comprise either or both of a ferrite and a shielding means.

In another aspect the invention broadly provides a vehicle including a wireless power transfer antenna or coupling device operable to provide a field for wireless power transfer in the vicinity of an occupant of a passenger seat.

In one embodiment the field is suitable for providing power to a passenger entertainment or communication device such as without limitation a headset, earpiece, glasses, phone, tablet or other portable electronic device.

In one embodiment the coupling device provides a field which also contains information for reception by a passenger entertainment or communication device.

In another embodiment the coupling device facilitates communication between a passenger entertainment system and a passenger entertainment or communication device.

The field may be provided in a required location relative to the passenger seat. For example, the field may be provided adjacent to the head of a user (i.e. passenger or seat occupant), or the head and torso of a user.

In an embodiment the relative location may be selected by placement of a plurality of field transmitters.

In an embodiment the field may provide to the seat by a removeable or attachable body.

In one embodiment the coupling device is provided in or on a passenger seat. The field from the device may be projected into a defined area, so in some embodiments the device may be located in or on or adjacent to the headrest of the seat to direct the field into a space normally occupied by the seat occupant. In other embodiments the device may be located in a seat in front of the seat occupant.

In another embodiment the coupling device is provided in the vehicle externally of the seat. For example the device may be located above or below the seat, but be adapted to provide a field in the required location, or at least a field that extends to the required location.

In one embodiment the device includes a coil which is shaped or energised to provide a filed have the required spatial characteristics. In other embodiments the device includes materials to shape or direct the field e.g. materials that reflect and/or absorb parts or components of the field to attain the required spatial characteristics.

In an embodiment the spatial characteristic is achieved through the position and orientation of a plurality of coils.

Preferably the vehicle comprises an aircraft.

In another aspect the invention broadly provides a passenger entertainment system comprising a media delivery or communications system including at least one wireless power transfer antenna or coupling device operable to provide a field for wireless power transfer in the vicinity of an occupant of a passenger seat.

The system also preferably includes one or more passenger entertainment or communication devices, each device capable of being wirelessly coupled to the coupling device.

In one embodiment the field is suitable for providing power to a passenger entertainment or communication device such as without limitation a headset, earpiece, glasses, phone, tablet or other portable electronic device.

In one embodiment the coupling device provides a field which also contains information for reception by a passenger entertainment or communication device.

In another embodiment the coupling device facilitates communication between a passenger entertainment system and a passenger entertainment or communication device.

The field may be provided in a required location relative to the passenger seat. For example, the field may be provided adjacent to the head of a user (i.e. passenger or seat occupant), or the head and torso of a user.

In one embodiment the coupling device is provided in or on a passenger seat. The field from the device may be projected into a defined area, so in some embodiments the device may be located in or on or adjacent to the headrest of the seat to direct the field into a space normally occupied by the seat occupant. In other embodiments the device may be located in a seat in front of the seat occupant.

In another embodiment the coupling device is provided externally of the seat. For example the device may be located above or below the seat, but be adapted to provide a field in the required location, or at least a field that extends to the required location.

In one embodiment the device includes a coil which is shaped or energised to provide a filed have the required spatial characteristics. In other embodiments the device includes materials to shape or direct the field e.g. materials that reflect and/or absorb parts or components of the field to attain the required spatial characteristics.

The disclosed subject matter also provides connector apparatus or connection of methods which may broadly be said to consist in the parts, elements and features referred to or indicated in this specification, individually or collectively, in any or all combinations of two or more of those parts, elements or features. Where specific integers are mentioned in this specification which have known equivalents in the art to which the invention relates, such known equivalents are deemed to be incorporated in the specification.

Further aspects of the invention, which should be considered in all its novel aspects, will become apparent from the following description.

### DRAWING DESCRIPTION

A number of embodiments of the invention will now be described by way of example with reference to the drawings in which:

FIG. 1 is a diagrammatic illustration of a passenger seating arrangement including one embodiment of a wireless passenger entertainment system according to the invention.

FIG. 2 is a diagrammatic illustration of a passenger seating arrangement including another embodiment of a wireless passenger entertainment system according to the invention.

FIG. 3 is a diagrammatic illustration of a passenger seating arrangement including yet another embodiment of a wireless passenger entertainment system according to the invention.

FIGS. 4a, b, c, d and e are diagrams showing embodiments of a transceiver mounted in a headrest that may be removable.

FIGS. 5a and b show a transmitting coil with shielding and ferrite layers

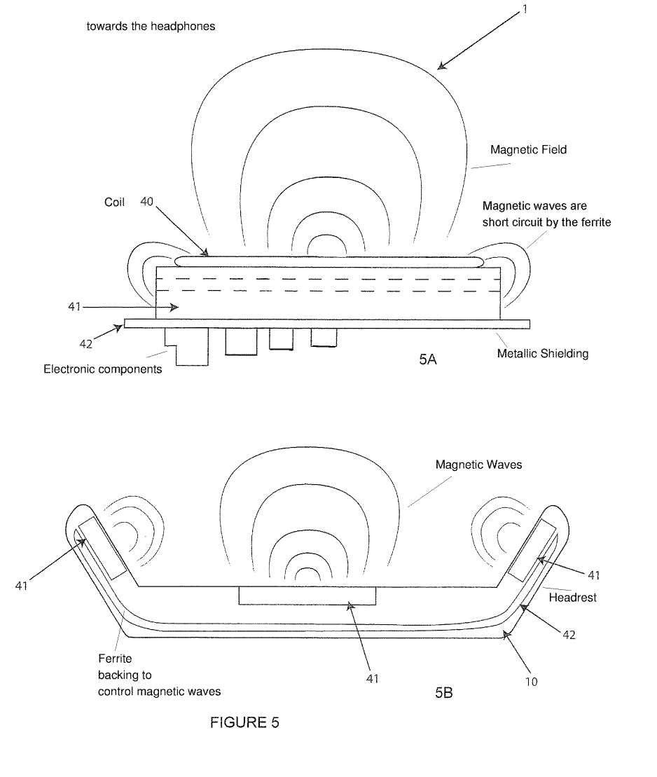

FIGS. 6a and b shows resonant repeaters or multiple transmitters located in a passenger seat.

FIG. 7 shows an embodiment of the signals of a dual tuned coil with audio and volume data being transmitted.

FIGS. 8a and b show a circuit diagram of an embodiment of a transmitter and receiver and the signals transmitted.

### DETAILED DESCRIPTION OF THE DRAWINGS

Throughout the description like reference numerals will be used to refer to like features in different embodiments.

As mentioned above, the invention is applicable to passenger communication and/or entertainment systems. Thus, although the disclosure below discusses an IFE system, it will be understood that this is but one example of a number of different possible applications of the invention.

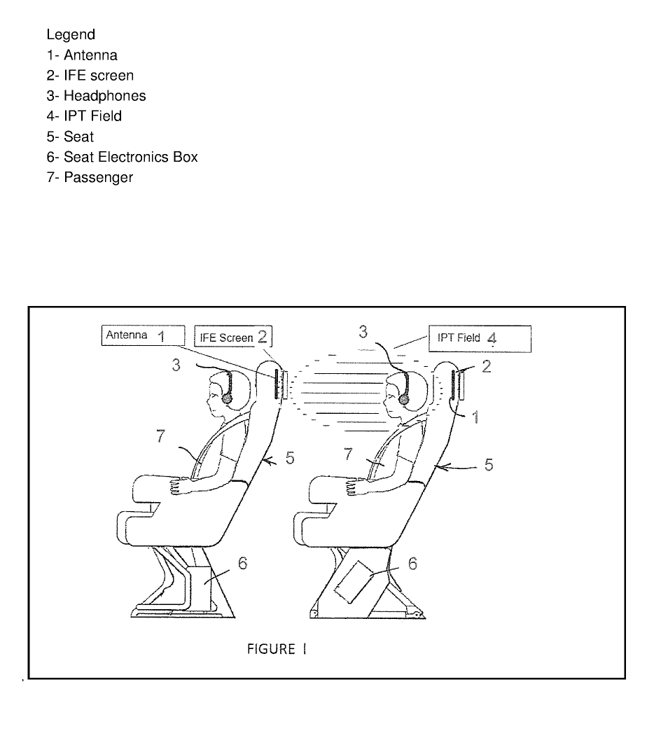

Referring first to FIG. 1 a passenger environment is shown. In one embodiment the passenger environment may be on an aircraft. The passenger environment may comprise a plurality of seats 5. Each seat 5 may comprise or include various IFE features including an IFE screen 2, a seat electronics box (SEB) 6, control means and connection apparatus. In some embodiments certain IFE elements may be shared between multiple seats, in particular a SEB may be shared between multiple seats. The seat 5 may be a single or a group of connected seats. Dependant on the aircraft or vehicle arrangement there may be many seats arranged in a compact space. In some embodiments IFE elements for one seat may be placed on another seat (for instance the seat in-front). This may, for instance, be for ease of use or to provide improved access.

FIG. 1 shows a wireless coupling device which is referred to herein as a transmitter or antenna 1 in each seat. As will become apparent form the following description, the coupling device may simply transfer power (continually or periodically or intermittently), and/or may provide information or a communication function. Thus although the term transmitter is used in this description, it will be appreciated that it is not limited to a transmitting function, as it may also be used to receive information.

In the embodiment shown in FIG. 1 a plurality of transmitters 1 are provided and are located on or in the back of each set. Each transmitter may then be associated with a physical spatial transmission area and/or set of headphones. For instance the transmitter could be directed so that it transmits to an area of the seat behind. The transmitter 1 may be a separate component of the IFE system or may be combined or attached to another component such as an IFE screen. In an embodiment a plurality of transmitters may be used which create an area of field in a specific area of the plane. For instance the two antennae 1 shown in FIG. 1 may be set up so as to provide a field between them. This would limit the leakage field from the antennae. In a system comprising a plurality of transmitters these may be arranged to form a row or corridor in which the field exists. This may help to overcome issues of head movement or field drop off as well as potentially supplying power to other devices in the field area or field corridor. In a particular embodiment a corridor may be established parallel or perpendicular to a row of seats.

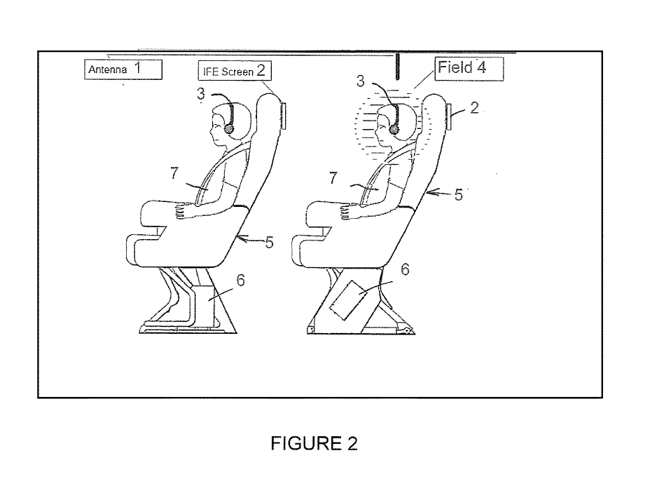

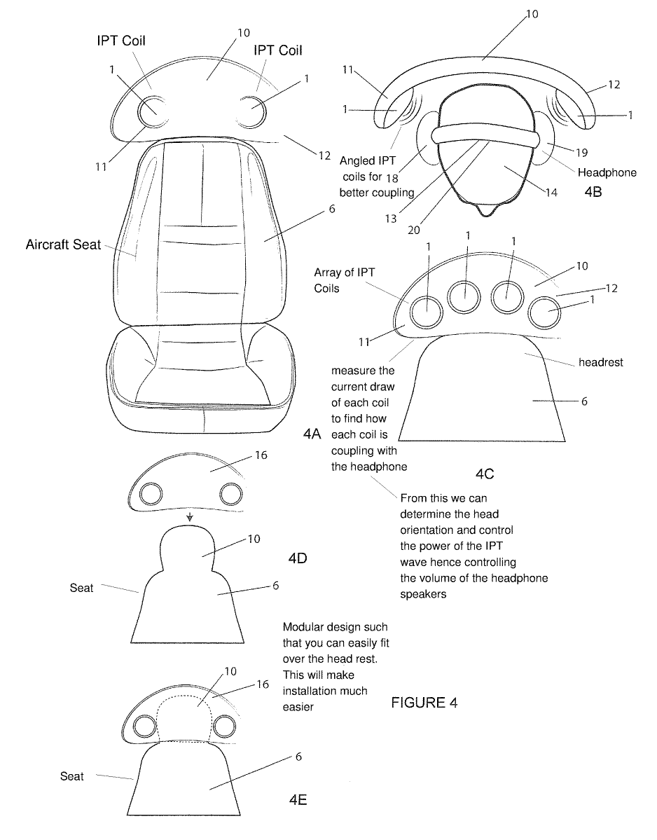

In alternative embodiments the transmitters are located in alternative positions. For example, FIG. 2 demonstrates a transmitter located above an aircraft seat. In this case the transmitter may be attached to, or obscured behind, a lower surface of the aircraft roof. As shown in FIG. 4a in an embodiment the transmitters 1 are located in alternative positions on the seat. The seat 6 has a headrest 10 with a first 11 and second arm 12. Each arm has a transmitter 1. In a preferred embodiment, as seen in FIG. 4b, the arms 11, 12 are angled. This angle provides comfort and support to a user's head 14 as well as improving the coupling between transmitters 1 and receivers located in the headphone 13. In an embodiment the transmitters may be located elsewhere in, on or adjacent the seat in some form of array or row or column to provide a field directed to a required location or able to be directed to the specific location of the headset.

Alternative embodiments, as shown in FIG. 4c, may have a plurality of the coils 1 arranged along the arms 11, 12 and body of the headrest 10, or another portion of the seat 6. By creating a field from multiple coils and monitoring the current drawn by each of the coils (i.e. by a measurement means or device such as a microcontroller, current transducer or ammeter) the amount of coupling between the transmitters 1 and a receiver (i.e. in the headset 13) can be determined. If the array of transmitters is suitable this may allow the position of the headphones 13 to be determined and allow adjustment of an electrical characteristic such as the power or volume supplied to the headphones, In the embodiment of 4c four transmitters are used in a horizontal array. The coupling between the transmitters 1 and a passenger electronic device 13 can determine the location of the passenger electronic device and a suitable energising of the coils to provide a filed in the desired spatial location or required location. In alternative embodiments the coils may share a spatial area or there may be separate coils for the proximity or position location and the transmission of power and/or information.

In a further embodiment shown in FIGS. 4D and 4E the transceivers may not be permanently mounted to the seat but may form a removable headrest or a cover for a headrest. In alternative embodiments the support means may be a plurality of pieces which may be separably mounted. This support means for the transmitters is preferably able to be removed and reattached as required, but affixed in such a manner that it will not easily slip off or can be removed by a passenger. For instance the transmitters 1 may be flat wound could printed on a flexible substrate such as a flexible PCB. The transmitters 1 or substrate 16 could them be encapsulated in a protective sheath, or mounted on or in a fabric layer, or otherwise arranged, so as to be connectable to an aircraft seat 6 or headrest 10. In an embodiment the transmitters may form part of a replacement headrest or headrest cushioned support. In this way a simple means is provided for retrofitting the transmitters to a current aircraft environment. In a further embodiment the coils are also placed on the reverse of the aircraft seat for supply of power to the user behind. An electrical connection to the transmitter support 16 could be made by wireless or wired means to a seat electronics box (SEB) or similar unit. If a failure or breakage occurred this unit would also be easily replaceable by removal and reattachment of a replacement transmitter support 16. The support 16 may be attached by Velcro or adhesive or other reversible or permanent attachment means.

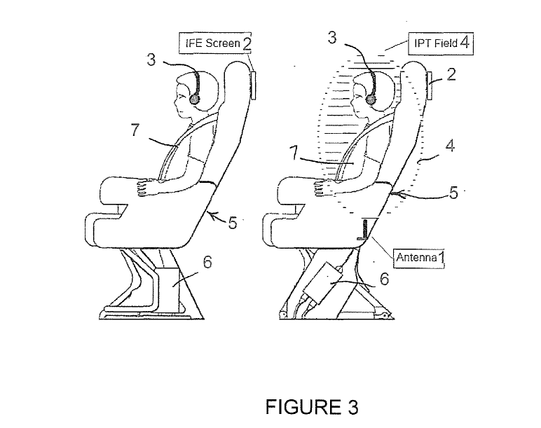

FIG. 3 shows a transmitter 1 located on a seat and associated with an area or user of the same seat. The transmitter may form part of the seat. The transmitter the transmitter comprises a field generating means such as a coil 40. The transmitter means may also comprise a ferrite layer 41 and/or a shield layer, e.g. of aluminium. The ferrite and aluminium layer may be used to protect electronics or to reduce the field leakage or improve field direction. For instance the ferrite backing means may short circuit the magnetic fields and encourage the field in a direction away from the coil and towards the headphones. The shield means may limit or stop transmission of the field in a particular direction. This may be useful to protect electronics or to avoid field crossover between nearby passengers. The ferrite and shield means may be incorporated for each coil individually or may be provided for a plurality of could, for instance in a removable headrest 10.

In an embodiment the transmitters comprise multiple transmitter coils. The coils may be wound around substantially the same centre point. Multiple coils may be used to provide multiple signals to the receivers (which may also have multiple coils, or a single coil and a filter means). For instance a transmitter may wish to send a power and control signal (e.g. volume control) to the headphones and this may be accomplished using coils at different resonant frequencies but at the same spatial location. Alternatively a single coil may be operated at two frequencies (dual tuned) to supply the two signals. The control signal may comprise a data signal, a volume signal, a sound type signal or other electrical signals the passenger device may require.

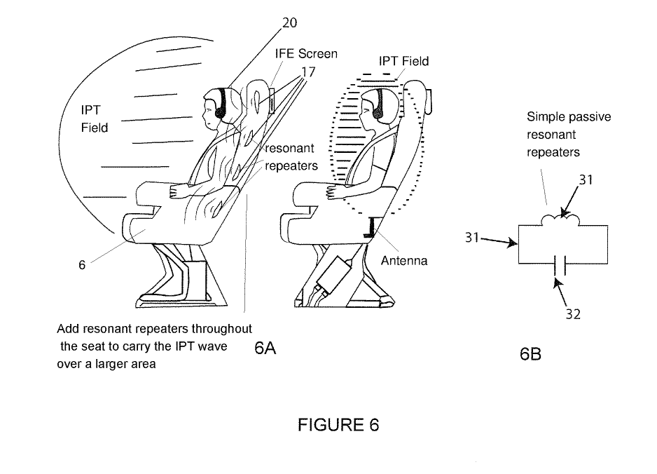

In each case the location of the transmitter 1 provides access to one or passengers or users of the system. The field 4 produced by the transmitter is preferably designed to be limited to a spatial area surrounding the user. The shape and size of the spatial area of the field may be dependent on the placement of the transmitters. Preferably the spatial area of the field is defined by an area within which the signal is above a minimum level. In a preferred embodiment the field is short in range, for instance confined to the area of a single passenger head. Alternatively the field 4 from a single transmitter 1 may provide a signal to a group of passengers in close proximity. For instance the group of passengers may be in a row or column of seats and a plurality of receivers may form a chain or corridor connecting them. This arrangement may allow further cost and weight savings. When a single transmitter is providing a signal to multiple seat locations or users an identical signal may be provided to each user, or each user may receive the same signal. A single transmitter capable of providing a single to multiple locations may be used to provide a group of passengers with the option of receiving a signal simultaneously. In an embodiment as shown in FIG. 6A a plurality of transmitters 1 may be used to create a field that carries over a larger area of a seat. In an embodiment at least some of these transmitters may instead be resonant repeaters 17 which are not powered directly but which pick up a field and extend it. A simple passive resonant repeater 31 shown in FIG. 6B may comprise an inductor 31 and capacitor 33. More complex resonant repeaters may have further electrical components and/or require a power source.

The transmitter is adapted to transmit or receive a signal. In one embodiment the signal provides a power signal to an electronic device which may interact with a user. Suitable user devices include, but are not limited to, headphones 3, display devices, video glasses, video headsets, telephones and handheld games. The power supply can be provided by an inductive power transfer (IPT) system. The electronic device may be adapted to receive the power signal and operate. Correct operation may be indicated on the electronic device in some audio/visual means, for instance a light or LED. In some embodiments the user device may comprise a battery and the IPT system may be used to maintain charge in the battery. In some embodiments multiple electronic devices, associated with single or multiple seat locations may be charged by a single transmitter signal.

The electronic device may be adapted to improve the coupling between the transmitter 1 and the electronic device, e.g. headphones 13. A receiving coli (or transceiver coil) may be position in either of the earpieces 18, 19 or the headband 20. In an embodiment the headband, or another portion of the electronic device, may be positioned so as to improve coupling with the transmitters 1. For instance the headband may be provided at the back of the neck with a coil region located along a section of this band to provide a close coupling connection to a transmitter 1 located in the seat 6 or headrest 10. Similarly the orientation of the coils or transceivers in the electronic device may be adjusted to align with the transmitters 1. For instance the coils may not be parallel with the earpieces housing but may be positioned at an angle closer to that of the headrest arms 11, 12.

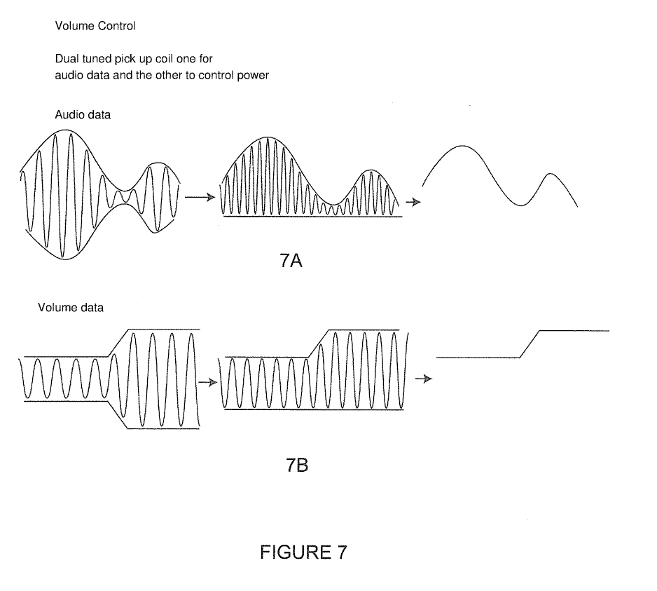

In one embodiment the transmitted and/or received signal may comprise a power and a communication signal. The communication signal may contain audio and/or a visual data and/or control signals. In a preferred embodiment the communications signal may use the power signal as a carrier wave. The power signal may be modulated by the communications signal to provide a single signal. In one alternative the communications and power signals may be separately sent using a single transmitter, multiple connected transmitters or two transmitters. For instance, the communications signal may be amplitude modulated (AM) or frequency modulated (FM) into the power signal. The modulation may be encoded by analogue or digital means. This reduces the number of signals being transmitted and the number of frequencies or bandwidth being used by the signals. In an embodiment an MA carrier wave may be used to supply the audio data by varying the amplitude of the resonant signal. To ensure an appropriate voltage is maintained a voltage limiting means, such as a simple electronic or logic circuit may be used in the headphones to limit the maximum volume. The control signal may also be used to supply information or volume characteristics to the headphones or electronic device. The volume information (or other audio characteristic information) may depend on the audio volume and the position or coupling of the headphones and the passenger. An example of the AM modulation at two frequencies is shown in FIGS. 7a and 7b.

The transmitters may have one or a plurality of operating modes. In one embodiment at least two modes are present, a fully on, or emission mode, and a standby mode. The standby mode may result in low power consumption or a reduced magnetic field. The standby mode may also result in a change in the signal, for instance any communication signal may be suspended or altered. The operation of standby mode may be physically chosen or may be automatically changed, for example when a suitable electronic device is within range or in the spatial area of the field. Similarly the transmitter or transceiver may switch to standby mode when all suitable electronic devices are removed from the spatial area of the field. The fully on, or emission mode may provide the maximum, or a set limit, of power and/or communication to the associated spatial area. In further embodiments a range of power modes may be available dependent on the type of electronic device present in the spatial area, the communications between the electronic device and the transmitter or transmitter settings.

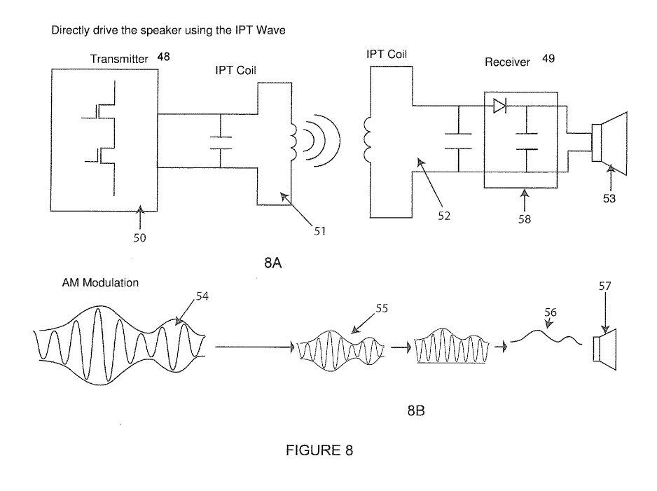

In a preferred embodiment the electronic device, for instance a headphone 20 may be driven directly by the IPT input. This may avoid or at least reduce the capacity of, any battery requirement in the headphone reducing cost and complexity of the headphone. FIG. 8 shows the transmitter 48 using, for instance, a PWM signal or digital signal to generate an IPT field. The field is the received by the Receiver 49 resonant circuit 52 and provided to the load, i.e. speaker 53. In the embodiment shown in FIG. 8b the AM modulated signal produced by the transmitter 48 is broken into its parts in the receiver 49. The transmitted wave 55 comprises an amplitude based signal overlaid on a resonant frequency oscillation. The receiver must then remove the resonant oscillation, for instance by filtering 58, for instance by using a capacitor, to leave the audio signal 56 to flow to the speaker. In this embodiment the receiver may be analogous to a crystal radio in which the power and signal are drawn from the signal source and no external power source is required. In an alternative embodiment FM modulation could be used, however this may have to be limited in extent to remain within a suitable resonant frequency for operation. In an embodiment any loss in the coupling due to a change in frequency could be pre-compensated for in the receiver, as could losses due to the amplification. In some embodiments the resonant circuit of the transmitter and receiver may be used in reverse to provide information back to the SEB or IFE system. This system has the advantage of a very simple receiver in the wireless headset.

In some embodiments the receiver may comprise further electronic components for controlling voltage (and therefore volume). In an embodiment the voltage control may be on the transmitter side of the power transmission. The current may be monitored to ensure the coupling level is known and that a suitable voltage for transmission may be calculated. If, for instance, the coupling is found to be weak the volume may be increased to make the passenger experience a constant level of sound. Similarly the voltage may be decreased as the coupling improves. In alternative embodiments the coupling may be monitored by a proximity detection means such as infrared, ultrasonic or optical or by electronic means such as a plurality of transmitters 1.

As indicated above the transmitters may operate as a transceiver capable of receiving and transmitting communication in some embodiments. In these embodiments the electronic device may also include a transceiver or be otherwise adapted for two way communication. In one embodiment the two-way communication allows the transmitters to receive information about the environment of the electronic device. In a first example the electronic device may comprise a set of headphones and may comprise a microphone. The output of the microphone may be transmitted through the transmitter to the IFE system to assist in a noise cancellation system. The communication in each direction between the transmitters and electronic device may operate independently or using the same communication means. This may be further combined with the wireless power means. In a second example the electronic device may comprise a transmitter and speaker capable of providing the audio inputs and outputs for telephone calls. The wireless signal between the transmitter and the user device may then be used to allow voice over IP or other telephone calls by linking the electronic device wirelessly to the IFE system or suitable network.

The transmitter 1 may have a separate antenna that provides communication capability if required. If the transmitter provides both power and communication, then one approach is to conveyed information by modulating the field by which power is provided. In one embodiment information or communication may be provided by infrared for example, while power is provided separately by transmitter 1.

The transmitter 1 is preferably structured to provide the required field which attenuate relatively quickly so that the field is substantially limited to a required physical space. The transmitter may comprise a coil such as a solenoidal structure with reflectors and/absorbers to ensure that the field has the required space. Alternatively, other coil arrangements may be used.

Different information or communication channels may be operated at different frequencies. In some embodiments, different channels are synchronised and/or paired with different users. RFID systems may assist with this.

The devices which the passenger uses with this system each have a reception (which may also double as a transmission) device that may typically comprise a coil which is tuned to the frequency of the field from the transmitter. This can be provided within the body or housing of the device, or could be provided separately as an attachment—for example a small device that a passenger could plug onto or into a mobile phone or tablet.

The passenger devices may be charged intermittently by multiplexing the operation of the transmitters 1. Moreover, the passenger devices may be charged wirelessly while in storage in between flights which may allow weaker fields to be used within the cabin environment.

From the foregoing it will be seen that a wireless transmitter is provided which allows electronic devices to be provided with power and/or communication signals.

Unless the context clearly requires otherwise, throughout the description, the words “comprise”, “comprising”, and the like, are to be construed in an inclusive sense as opposed to an exclusive or exhaustive sense, that is to say, in the sense of “including, but not limited to”.

Although this invention has been described by way of example and with reference to possible embodiments thereof, it is to be understood that modifications or improvements may be made thereto without departing from the scope of the invention. The invention may also be said broadly to consist in the parts, elements and features referred to or indicated in the specification of the application, individually or collectively, in any or all combinations of two or more of said parts, elements or features. Furthermore, where reference has been made to specific components or integers of the invention having known equivalents, then such equivalents are herein incorporated as if individually set forth.

Any discussion of the prior art throughout the specification should in no way be considered as an admission that such prior art is widely known or forms part of common general knowledge in the field.

What we claim is:

1. A passenger communication apparatus comprising:
a wireless power coupling device operable to provide a field for wireless power transfer in the vicinity of an occupant of a passenger seat to be received by a passenger device.

2. A passenger communication apparatus as claimed in claim 1 wherein the field contains a power signal and an information signal for transmission to the passenger device.

3. A passenger communication apparatus as claimed in either of claim 1 or 2 wherein the field is provided in a required location relative to the passenger seat.

4. A passenger communication apparatus as claimed in any one of claims 1 to 3 wherein the required location of the field is selected by positioning a plurality of coupling devices.

5. A passenger communication apparatus as claimed in claim 4 wherein the relative coupling between the coupling devices and the passenger device acts as a position detector for the passenger device.

6. A passenger communication apparatus as claimed in any one of claims 1 to 5 wherein the coupling device is provided in or on or adjacent to the passenger seat.

7. A passenger communication apparatus as claimed in claim 6 wherein the coupling device is provided on the headrest of the passenger seat to provide the field in a space normally occupied by the seat occupant.

8. A passenger communication apparatus as claimed in either one of claim 6 or 7 comprising a plurality of coupling devices located in or on a head portion of the passenger seat and wherein the coupling devices are arranged with different positions or orientations to provide power to the passenger seat.

9. A passenger communication apparatus as claimed in any one of claims 1 to 8 wherein the coupling device is located on a support means which is attachable to a passenger seat.

10. A passenger communication apparatus as claimed in claim 9 wherein the coupling device is located on a flexible support means.

11. A passenger communication apparatus as claimed in either one of claim 9 or 10 wherein the coupling device is removably attachable to a portion of a seat.

12. A passenger communication apparatus as claimed in any one of claims 1 to 11 wherein the passenger device is powered by and receives an electrical signal from the device.

13. A passenger communication apparatus as claimed in claim 12 wherein the passenger device has a speaker means which is powered directly from the audio signal.

14. A passenger communication apparatus as claimed in any one of claims 1 to 13 comprising a plurality of coupling devices, a first coupling device located in, or on, or adjacent to a seat and a second coupling device located on an adjacent seat, operable to create a field in an area covering at least one of the seats.

15. A passenger communication apparatus as claimed in any one of claims 1 to 14 wherein the coupling device comprises materials to shape or direct the field.

16. A passenger communication apparatus as claimed in claim 15 wherein the materials comprise either or both of a ferrite and a shielding means.

17. A passenger communication apparatus as claimed in any one of claims 2 to 16, when dependent on claim 2, wherein the power signal is a carrier wave for the information signal.

18. A passenger communication apparatus as claimed claim 17 wherein the information signal is carried by amplitude modulation or frequency modulation.

19. A passenger communication apparatus as claimed in any one of claims 1 to 18 wherein the coupling device has a plurality of resonant frequencies and wherein:
a first resonant frequency is adapted to transmit power signal; and
a second resonant frequency is adapted to transmit a data signal.

20. A passenger communication apparatus as claimed in any one of claims 1 to 19 wherein the coupling device comprises a coil which is shaped or energised to provide a field have the required spatial characteristics.

21. A passenger entertainment system comprising a media delivery system for an aircraft comprising a wireless power coupling device operable to provide a field for wireless power transfer in the vicinity of an occupant of a passenger seat.

22. A passenger entertainment system as claimed in claim 35 comprising a passenger entertainment or communication devices, each device capable of being wirelessly coupled to the coupling device.

23. A passenger entertainment device comprising:
a wireless power coupling device operable to receive a field for wireless power transfer provided by a passenger entertainment system.

24. A passenger entertainment device as claimed in claim 37 wherein the wireless power coupling device is operable to receive a power signal and a communications signal from the field.

25. A passenger communication apparatus as claimed in any one of claims 1 to 3 wherein the required location of the field is selected by positioning a plurality of field repeaters.

26. A passenger communication apparatus as claimed in any one of claims 1 to 3 wherein the required location of the field is selected by positioning at least one coupling devices and at least one field repeater.
